(19) United States
(12) Patent Application Publication
(10) Pub. No.: US 2010/0094693 A1
(43) Pub. Date: Apr. 15, 2010

(54) OFFER OR REWARD SYSTEM USING CONSUMER BEHAVIOUR MODELING

(76) Inventor: Anthony Corke, Sydney (AU)

Correspondence Address: DICKSTEIN SHAPIRO LLP, 1825 EYE STREET NW, Washington, DC, 20006-5403, US

(21) Appl. No.: 12/444,496

(22) PCT Filed: Oct. 3, 2007
(86) PCT No.: PCT/GB07/03753

§ 371 Date: Dec. 22, 2009

(30) Foreign Application Priority Data
Oct. 4, 2006 (AU) 2006905467

(51) Int. Cl. G06Q 30/00; G06Q 10/00; G06Q 50/00

(52) U.S. Cl. 705/14.13; 705/14.25; 705/14.38

(57) ABSTRACT

The invention relates to a method of consumer modelling for sales' promotions, comprising the steps of providing a plurality of points of sale, providing a plurality of computer devices respectively adapted to analyse consumer behaviour and deliver data based thereon to a point of sale, and providing a device associated with an individual point of sale of the plurality thereof for providing at least promotional material to a consumer making a sales' transaction at any individual point of sale. Thus, in the drawings, there is shown a point of sale location (1) which includes a scanner (2) of data relating to goods purchased by a consumer, not shown, a printer (3) for the transaction, a point of sale screen (4) at a point of sale transaction device (5) and a dedicated printer device (6). The device 5 runs the POS software and can also store the targeted promotional material such as comprising couponing when the application is a couponing application, and also stores image(s) and text(s) required for coupons to be printed. The dedicated printer 6 can print out a coupon or coupons at any point during a sale's transaction. The application determines what is displayed on the screen (4).

The present invention relates to modelling of customer behaviour for the purpose of sales promotions and more particularly relates to the creation of redemption modelling for the purpose of making offers to customers demonstrating patterns of consumption behaviour.

There are in existence a wide variety of sales promotion methods and techniques which aim to create brand loyalty, brand switching and higher sales volumes. Among the methods available are those which exist at point of sale terminals. A most basic form of such promotion is advertising on shopping receipts which either advertise products or offer incentives to consumers at a point of sale to purchase products.

Ultimately, every advertiser's sales promotion seeks to change consumer behaviour—to have consumers buy more of some product now, to buy product A instead of product B, or to think more highly of company X products now and so buy more of its products later.

In some cases this behavioural change is encouraged by describing the potential benefits of the change. For example, an advertisement in which the unique features of a particular product are demonstrated. In other cases, encouragement comes in the form of a financial incentive to change, or what the marketers call an “offer”. This might, for example, be in the form of a coupon which, when presented, entitles the holder to 10% off the normal purchase price of some product or service.

With the growing availability of computing power and off-the-shelf statistical packages, predictive modeling has become a widely-used tool to assist advertisers in targeting their offers at point-of-sale, that is, in identifying the most propitious individuals or transactions at which to make a particular offer.

To do this, the known models have either assumed that information about the consumer conducting the current transaction (such as age, sex or previous purchase behaviour) has been previously collected and is available, or the presence of one or more specific items in the current purchase is a sufficient basis on which to target a consumer for an offer. However, in practice, for many transactions no information exists or is available about the individual performing it and the need for rapid transaction processing precludes looking for and responding to all the products in the current purchase.

The prior art does teach some forms of consumer behaviour modeling. One example of a prior art modeling method is disclosed in U.S. patent application Ser. No. 09/639,736. This discloses a promotional method in which a behaviour model is implemented for every customer and every offer so as to construct personalised offers with maximum predicted impact relative to target function. After matching offers to customers personalised sets of offers are made to target customers.

This form of modeling is specific to individual consumers and does not have a predictive capability based upon criteria other than actual consumer purchasing or on an actual purchasing pattern. The behaviour model according to the U.S. patent application is to use the data to increase redemption rates, increasing revenue or a combination of these in addition to achieving marketing goals, increasing sales etc. The marketing method is heavily based on marketing behaviour of customers and selection of optimal customers and using collected data to derive, using a software module, one or more behaviour models for every customer so as to construct personalised offers with maximum predicted impact relative to a target function. The redemption behaviour model contemplated is in a broad sense disclosed in the US specification. However, the US specification does not teach maximising cross visitation between retailers where there are a potentially unlimited number of retailers/participants.

It is an object of the invention to seek to provide an alternative to the known consumer modeling systems by providing redemption modeling for the purpose of making offers to customers demonstrating patterns of consumption behaviour.

According to the invention there is provided a method of consumer modelling for sales' promotions, comprising the steps of providing a plurality of points of sale, providing a plurality of computer devices respectively adapted to analyse consumer behaviour and deliver data based thereon to a point of sale, and providing a device associated with an individual point of sale of the plurality thereof for providing at least promotional material to a consumer making a sales' transaction at any individual point of sale.

According to the invention there is also provided a system for providing consumer modelling of for sales' promotions, comprising a plurality of points of sale, a plurality of computer devices respectively adapted to analyse consumer behaviour and deliver data based thereon to a point of sale, and a device associated with an individual point of sale for providing at least promotional material to a consumer when making a sales' transaction at any individual point of sale.

The present invention differs from the known promotion systems in that, for optimization, a predictive model can be created based on wider criteria than particulars of individual consumer transactions. A predictive model may therefore be established from information available for each offer about;
the retail locations at which a promotional offer, or offers sufficiently similar to it, were previously made,
the characterising features of the offer that was or offers that were made (eg the type of product or service to which the offer refers,
the generic type of the offer (eg percentage discount, buy one get one free)
the actual or perceived value of the offer to a redeeming consumer,
the number of days to expiry of the offer on which the similarity of offers will be based,
the redemption rate of the offer (howsoever that redemption was made),
other offers with which the offer appeared and the location at which the offer was issued when it was redeemed other offers with which the offer appeared and the location at which the offer was issued when it was not redeemed.

It will be understood that reference herein to a point of sale (POS) is one selected from a plurality or network of such points of sale, spanning a number of disparate locations and retailers, which may be unaffiliated.

According to one embodiment of the invention, the predictive models draw their predictive capacity from specific and generalisable knowledge about which offers, when delivered at a particular retail location and in concert with a range of other offers, have proved most effective in eliciting consumer response.

An advantage of the present invention is that ‘optimisation’—that is, the determination of which set of offers to make at each retail location and in which order—can be performed offline and remotely. This results in a reduction of real-time load on the POS system. Once determined, the optimised groups of offers can be uploaded to the POS environment at a convenient and prescribed time.

The method and system embodying the invention also employs predictive modeling techniques, but departs from earlier uses in that it employs the predictive models within a system that:
simultaneously considers offers from a range of advertisers;
simultaneously considers delivery of these offers at a range of distinct retailers (ie retailers that are part of different franchises or organisations);
allows for the preferential treatment of some advertisers over others;
assembles groups of offers to be made as part of a single transaction;
identifies the ‘best’ order in which to present the offers within the group of offers;
takes into account the retail location at which the offers will physically be delivered (ie printed, displayed or otherwise transmitted to a consumer);
imposes constraints on the assembled groups of offers (for example, that an offer from Advertiser A cannot appear in the same group as an offer from Advertiser B, or that an offer from Advertiser C cannot appear in a group of offers to be ‘made’ at retail location R).

In a preferred embodiment, there is generated sets of optimised offers for a given number of retailers (known as ‘hosts’ or ‘locations’), each with a given, fixed capacity to issue groups of offers. In the optimum solution no offer may appear in more than a predetermined number of offer sets (note that this predetermined number may vary across offers).

It will be understood that optimality is measured by the proportion of offer sets from which at least one offer is redeemed. A less optimal solution will be accepted over a more optimal one if and only if: it provides a superior outcome for some premium advertiser in a manner which is described in steps 2 and 6 below and it is necessary to meet any promised constraints regarding the placement of offers relative to certain hosts or other offers.

Thus in one broad form the present invention comprises:
A method of creating sets of sales promotions optimized for transmission to a selected location and/or selected recipients or groups of recipients, the method comprising the steps of:
a) creating a data base from data drawn from commercial activity at at least one point of sale;
b) using said data to determine a notional allocation of offers to hosts identified as maximizing an identified target function;
c) determining said allocation according to one or more of the following criteria:
   i) constraints relating to offers that cannot be allocated to a specific host;
   ii) available stock of the relevant product or service made in each offer; and
   iii) the capacity of each host to make offers;
   d) predicting from said data in said data base, a redemption rate of an offer or set of offers transmitted to a specific host or host type;
   e) collating an offer or sets of offers and allocating those offers for a particular host or set of hosts to achieve a target function.

According to one embodiment, the host may be a selected retailer or category of retailers. Preferably the redemption rate is determined from the data by use of a prescriptive formula created from analysis of data collected on the data base. The redemption rate is preferably determined by reference to the data on the data base and criteria for allocation of the offers to pre selected hosts. According to one embodiment, the redemption rate is created by an algorithm. Throughout the specification, the term redemption rate will be taken to mean the take up rate of an offer or offers transmitted to a selected host or groups of hosts, measured to a commercially acceptable level of accuracy.

According to a preferred embodiment a predictive formula used is a Generalised Linear Model with a target variable being the redemption rate by offer and explanatory variables including information about the offer and the host at which the offer was issued.

In a particular embodiment, allocation of offers is achieved by use of a Linear Program with an objective function being a total number of expected redemptions and constraints including a maximum number of each offer that can be allocated to hosts and the maximum number of offers that can be allocated to any one host.

Also in one embodiment of the invention, additional constraints may be used to ensure that the notional allocation includes a minimum number of offers for preferred advertisers or a minimum number of allocated offers for preferred hosts. In a further embodiment, the prediction formula for determining the redemption rate is a random forest with a target variable used in the formula being a probability that at least one of the offers in a set be redeemed and explanatory variables include information about each offer and the position at which each appears in an offer set. Where there is a large enough pool of historical data that can be drawn on to build said random forest, it is preferable that the random forest is built on samples of available data with successive samples of data selected to ensure that they contain a larger proportion of observations that are misclassified by the random forest constructed to that point.

Preferably a formula which creates and manipulates sets of offers is a swapping algorithm that selects a preferred offer set allocation by swapping one offer in a first set of offers with another offer in a second set of offers allocated to the same host, and a target function is the number of offer sets from which it is expected that there will be at least one redemption.

### BRIEF DESCRIPTION OF DRAWINGS

The present invention is hereinafter described, by way of example, in more detail according to a preferred but non-limiting embodiment and with reference to the accompanying schematic drawings, wherein:

FIG. 1 shows a schematic layout of a series of steps which implement the invention according to one embodiment; and

FIG. 2 shows a schematic perspective view of a point of sale embodying the invention.

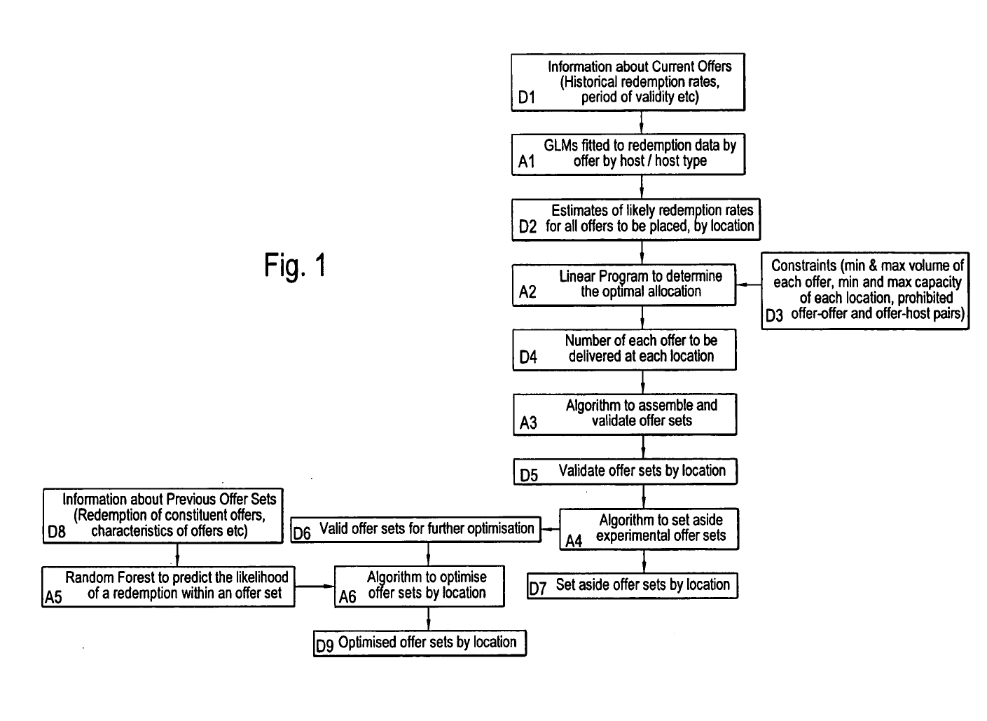

The invention according to a preferred embodiment will now be described in more detail with reference to FIG. 1 and to a six step process by which redemption rate is predicted from a redemption rate model established from a transaction activity data base.

It will be appreciated by persons skilled in the art that apart from the example to be described below, there are numerous permutations and combinations of offers based on offer criteria and host/consumer and consumer group criteria to be taken into account in calculating a redemption rate from redemption modeling for a particular type of host or consumer.

The predictive modeling according to the invention for instance takes into account individually or simultaneously offers from a range of advertisers, delivery of these offers at a range of distinct retailers and allows for the preferential treatment of some advertisers over others. Further the modeling takes into account groups of offers to be made to a single consumer and may identify an optimal order in which to present the offers within the group of offers. The modeling also takes into account the retail location at which the offers will physically be delivered and may place restrictions or impose constraints on the assembled groups of offers. The offers may be made host specific and limited to particular advertisers or goods and service providers. Thus constraints may be location based, host based or advertiser based.

Referring now to FIG. 1, which shows a series of steps which implement the invention:

Step 1:

This step produces an estimate, by host, of the likely redemption rate of the offers to be optimally placed in a current period (D2). In other words it should produce an estimate of the likely redemption rate of offer O if it is issued at host H for all combinations of O and H. These estimates are based on historical redemption rates recorded when the given offer has been issued by the specific host (D1). Since most live offers will not yet have expired when estimated redemption rates must be calculated, a means of extrapolating each live offer's performance over its remaining life is employed. One way of performing this extrapolation is to fit Generalised Linear Models to historical daily redemption figures for each host and offer (A1) and to assume that the redemption behaviour of a given live offer issued at a given host over its remaining ‘life’ (ie between the current date and the date on which it expires) will broadly mirror that of similar offers issued at the same or similar hosts.

In this step, no account is taken of any synergies amongst offers that might, for example, lead to higher (or lower) redemption rates than would be expected from considering offers on their own. For new offers and new hosts, no historical data will exist, so a ‘proxy’ offer or host is selected, and redemption rates estimated accordingly.

Ideally, this step would be based on, at least, the following input:
for historical offers (ie offers that have expired);
information on the number that were issued each day at each host;
the daily number of redemptions that were recorded (separately, for each issuing host);
the number of days that the offer was ‘live’;
characteristics that define the offer type (eg whether it is a percentage discount, a cents-off promotion or some other kind of offer);

characteristics that define each of the hosts through which the offer was made (eg whether it was an electronic equipment retailer, a fast food restaurant, and so on);

Step 2:

This step produces an initial allocation of offers to hosts (D4). Allocation is made with the aim of maximizing expected redemptions, subject to (D3):
maximum host and offer capacity;
meeting any constraints in relation to the placement of offers on the dockets of certain hosts (for example, that offers from retailer R are not to appear on dockets printed at a rival retailer S);
allowing for preferential treatment for premium advertisers (it is envisaged that advertiser status might, for example, be determined via tiered pricing or via an open bidding process);
ensuring that a ‘reasonable’ proportion of each host's capacity is filled and a ‘reasonable’ proportion of each offer is placed (this is achieved by employing minimum constraints in the optimization algorithm).

Such an optimal solution can be found by using a (constrained) linear programming approach (A2).

This step requires the following information:
The output of Step 1, the estimated redemption rate for each offer at each host;
The maximum number of times that each offer can appear in the solution;
The maximum number of sets of offers that can be issued by each host;
The number of offers in each set of offers for each host (note that this can vary by host);
A list of offers that are not to appear in the offer sets generated for a given host;
For each host, a minimum proportion of its capacity that should be filled (this might be set to higher values to provide preferential treatment to premium hosts);
For each offer, the minimum proportion of its available stock that should be filled (this might be set to higher values to provide preferential treatment to premium advertisers);
For every host-offer pair, the minimum number of such pairs that should appear in the solution (this is to cater for host offers being placed in the first position on all host offer sets). Where a host has more than one offer of its own that can appear as the first offer, the proportion of each such offer used could be made at random or on the basis of some previous knowledge of redemption behaviour.
Note that the approach allows for an estimate to be made of the reduction in overall redemptions as a direct result of any given constraint. This estimate might then be used as a reasonable basis on which, where appropriate, to set prices relating to that constraint.

Step 3:

This step produces an initial offer set solution, that is, groups of offers notionally allocated to a host (D5). Each offer set will be flagged as being ‘valid’ or ‘invalid’ depending on whether or not it meets all of the offer and host constraints (A3).

This step starts by creating initial offer sets consistent with the host-offer allocation volumes determined in step 2, ensuring that the first offer on all host offer sets is an offer for the relevant host (unless a particular host has opted not to include its own offers in offer sets to be issued by it).

Where a host offer has deliberately been placed in the first position in a host offer set it should be flagged as such so that it is not accidentally swapped out at a later point in the algorithm. Where a host has more than one offer of its own that can appear as the first offer, the choice of offer to appear on any given docket for that host may be made randomly or based on knowledge of previous redemption behaviour.

Each offer set is then reviewed and flagged as either ‘valid’ or ‘invalid’ depending on whether or not it meets all host and offer constraints. Next, a host is selected at random and two offer sets notionally assigned to it are selected at random, at least one of which is flagged ‘invalid’. An algorithm then determines whether both offer sets can be made valid by switching some of the offers within the sets. Such switching continues until a predetermined stopping criteria is met. Once switching has been completed, offer sets flagged as ‘invalid’ should be set aside and excluded from further consideration.

This step requires the following information:
the output of Step 2 which provides the allocation of offers;
for each host, a list of offers that are not to appear in offer sets to be issued by that host;
for each offer, a list of offers that are not to appear in the same offer set (which, as a matter of course, would usually include the offer itself so that no offer would appear more than once in the same offer set).

Step 4:

This optional step (A3) sets aside a predetermined proportion of all valid offer sets (D7) so that the redemption lift provided by the optimisation steps can be properly measured, leaving a set of valid offers for further optimization (D6). The redemption rate of the set-aside offer sets will form the benchmark against which the redemption lift provided by optimisation can be assessed.

This step requires the following information:
the output of Step 3 which provides groups of offers notionally allocated to a host; and
a value that represents the proportion of offer sets to be set aside.

Step 5:

This step builds a model of the redemption behaviour of offer sets (A5) using a sample of previously issued offer sets from which it will be possible to estimate the probability of at least one of the offers within the offer set being redeemed (D8). It is expected that there will be significant non-linear effects in such a model, including synergistic effects across offers in the same offer set. A consumer might, for example, be enticed back to a mall to redeem a “$5 off a CD” offer if the same offer set contains a “10% off a Stereo Hi-Fi” offer.

Whilst such non-linearities could, in theory, be incorporated in a Generalised Linear Model, parameterisation is likely to be an issue. For example, if there were 400 offers live in the system, it would require 79,800 parameters to cater for all the pairwise offer synergies. A random forest is ideal in such circumstances as it allows non-specified non-linearities to be modeled without the need for explicit parameterisation.

Notwithstanding these benefits, in order to build a useful model of redemption, it is expected that the key characteristics of offers and hosts will need to be extracted and parameterized (in D8). Step 5 which builds a model of redemption behaviour requires the following information:
a sufficiently large sample of issued offer sets for which all offers have expired unredeemed or all offers have expired and at least one has been redeemed (ie exclude any offer sets which currently have one or more unexpired offers).
For each of the offers in the sample offer sets, the following information, at least, is required:
the number of days that the offer was ‘live’;
characteristics that define the offer type (eg whether it is a percentage discount, a cents-off promotion or some other kind of offer);
characteristics that define each of the hosts through which the offer was made (eg whether it was an electronic equipment retailer, a fast food restaurant, and so on).

An arcing approach is adopted at this step in order to maximise the accuracy of the random forest without given the constraints of computing power and memory.

Step 6:

This step creates the final, optimised offer sets (D9). The offer sets that were available at the end of step 3 (D6) are valid but not optimised. This step (A6) proceeds by taking those offer sets, selecting a host at random, selecting two offer sets notionally assigned to that host and then making pairwise offer swaps that: do not invalidate a valid offer set AND improve the overall expected number of redemptions of at least one offer from within an offer set OR Improve the placement of an offer from a premium advertiser (ie by placing it in an offer set which has a higher probability of generating at least one redemption).

Such improvements can be assessed by using the redemption predictive algorithm created in step 5 (A5).

Such swapping should continue until some predetermined stopping criteria are met.

This step requires the following information:
the offer sets available at the end of step 3;
the random forest predictive algorithm created in step 5.

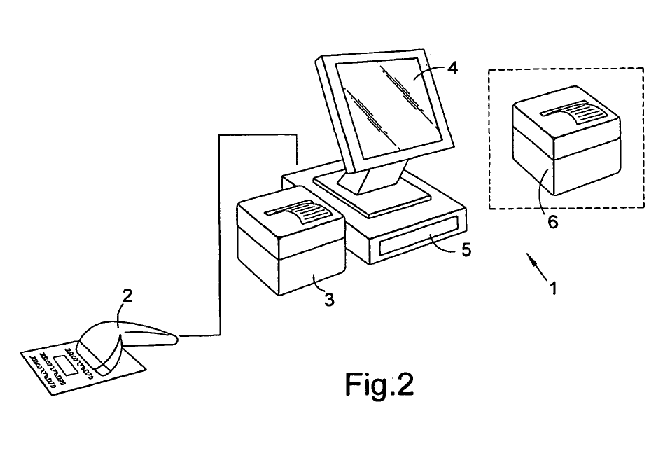

Referring now to FIG. 2, there is shown a point of sale location 1 which includes a scanner 2 of data relating to goods purchased by a consumer, not shown, a printer 3 for the transaction, a point of sale screen 4 at a point of sale transaction device 5 and a dedicated printer device 6. The device 5 runs the POS software and can also store the targeted promotional material such as comprising couponing when the application is a couponing application, and also stores image(s) and text(s) required for coupons to be printed. The dedicated printer 6 can print out a coupon or coupons at any point during a sale's transaction. The application determines what is displayed on the screen 4.

The proposed embodiments described are usually, but not specifically, for the Windows operating system that will be installed on a retailer's Windows-based POS system and be configured to run whenever the POS device on which it resides is switched on.

When running on the POS device, the application would listen in for information being sent to the POS device from the scanner or keyboard (using Windows API called SetWindowsHookEx which can intercept and filter key presses) and would take this as its cue to begin inspecting the information being passed to the PIOS screen. The purpose of this inspection would be to identify key pieces of information relating to the transaction in progress, namely:
The line description of each of the items being purchased
The price and quantity of each item.

In the ideal situation (i.e. where the POS application is running as a native windows application), the application would determine this information by inspecting text strings directly by traversing the window hierarchy and inspecting the contents of the screen using the GetWindowText API. Alternatively, if the application detects that it cannot directly collect such information (being unable to find any textual information after traversing the window hierarchy), it will commence taking ‘snapshots’ of the screen by recording a pixel-by-pixel copy of some or all of the screen information from the root window object.

The application will run in either of two modes:

1. Calibration Mode during which the application will employ what are called “Layout Analysis” techniques to parse the images that it captures to identify where key items such as line descriptions, prices, quantities and totals typically appear. Since the screen image is being captured on a pixel-by-pixel basis, an Optical Character Recognition (OCR) module will need to be included in our application. A number of off-the-shelf solutions are available for this component, and these will be preferred to any in-house solution.

Once the application has determined how to reliably parse the screen data for the particular POS device and screen on which it is running, it will create a stored profile that can be used as the basis for parsing the screen output of similar POS devices and screens.

Whilst the application is running in this mode it will capture everything that is being displayed on the entire desktop of the host PC, and

2. Data Capture Mode during which the application will parse each screen as it is captured and store the relevant constituent elements to a database that will also reside on the host PC. Whilst the primary basis for determining when to capture what is on the screen will be the recognition that a scan or keystroke has been received, the application might also be configured to take a snapshot of the screen after a certain period had elapsed since the previous capture.

For reasons of speed and efficiency, whilst the application is running in this mode it will capture only those portions of the screen that were identified as being relevant during the period when the application was running in Calibration Mode.

Because it is possible for changes to be made that will alter the way in which information is displayed on a screen (for example, the screen font might be changed or a retailer might update his or her address details on the POS device, and, in so doing, lengthen the display of this address on the screen), the application will, from time-to-time, check that the screen display has the key screen elements in the places that it expects them to be. (This can be done, for example, by checking the average colour of a screen region and comparing this with what would be expected if the screen layout had not been altered). One other simple check that the application can perform from time-to-time is that the screen resolution has not been changed.

If the application finds that it can no longer reliably recognise the screen layout it will revert to Calibration Mode and thereby learn how to recognise the new screen layout.

The invention further provides remote monitoring of consumer purchase behaviour at a point of sale to establish a model relative to a consumer or group of consumers based on which a consumer or consumers can be provided with offers at a point of sale or elsewhere as a reward for patterns of behaviour such as volume purchasing and the like. The invention further provides assembly of data for delivery of optimised sets of rewards or offers to target consumers and which may be transmitted and/or displayed randomly or specifically to a consumer at point-of-sale at a pre-determined local or remote retail location, or through other means of delivery such as a specific website, an in-store kiosk, a piece of addressed mail, or a mobile phone, with or without historical information about an individual consumer engaged in a specific commercial transaction.

Thus, in a preferred embodiment, the invention provides a method of creating sets of sales promotions optimized for transmission to a selected location and/or selected recipients or groups of recipients, the method comprising the steps of:
a) creating a data base from data drawn from commercial activity at at least one point of sale and by at least one consumer or at least one class of consumers;
b) using said data to determine said allocation of offers according to one or more of the following criteria:
   i) constraints relating to offers that cannot be allocated to a specific host;
   ii) available stock of the product or service that is the subject of each offer; and
   iii) the capacity of each host to make offers;
c) predicting from said data in said data base, a redemption rate of an offer or set of offers transmitted to a specific host or host type;
d) collating an offer or sets of offers and allocating those offers for a particular host or set of hosts to achieve a target function.

According to a preferred embodiment, the prediction of redemption rate is effected according to a formula determined from relationships between parameters in said data base drawn from prior transaction activity.

Moreover, it will be understood that in the preferred embodiments the steps of analysing consumer behaviour includes monitoring such behaviour and adding to it incrementally so as to produce an up-to-date “picture” of behaviour of a consumer. There is thus an accretion of data.

Also, software relating to consumer activity can be loaded at a POS, or on a remote computer or like device.

Throughout the specification a reference to optimized may be taken as a reference to qualify offers which are tailored to a particular location, groups of locations or host type so as to maximize the redemption rate of an offer or groups of offers such that redemption will be consistent with predicted uptake.

It will be understood that the invention herein described with reference to the drawings provides the technical effect of the creation of sets of offers for a plurality of points of sale and retailers, such that the created offer sets are optimal in that the proportion of offer sets from which at least one offer is to be expected to be redeemed is maximised, subject to offer, advertiser and stock constraints.

1. A method of consumer modelling for sales' promotions, comprising the steps of providing a plurality of points of sale, providing a plurality of computer devices respectively adapted to analyse consumer behaviour and deliver data based thereon to a point of sale, and providing a device associated with an individual point of sale of the plurality thereof for providing at least promotional material to a consumer making a sales' transaction at any individual point of sale.

2. A method according to claim 1, the plurality of points of sale comprising a network thereof.

3. A method according to claim 1, the dedicated device comprising a printer.

4. A method according to claim 1, the promotional material comprising a coupon relating to an offer, sale or redemption at a future sales' transaction at any one of the plurality of points of sale.

5. A method according to claim 1, comprising providing the steps of monitoring of consumer purchase behaviour at a point of sale of the plurality of points of sale.

6. A method according to claim 1, comprising the steps of monitoring consumer purchase behaviour via the computer device whereby to establish a model of consumer behaviour relative to a generic consumer.

7. A method according to claim 1, comprising the steps of assembly of consumer behaviour data for delivering optimised promotional material to a particular consumer for redemption at a point of sale selected from the plurality of points of sale.

8. A method according to claim 7, the data being delivered to the consumer via the means selected from the world wide web, internet, intranet, Ethernet, mobile telephone and mail.

9. A method according to claim 8, comprising the step of providing via the computer device historical information relating to a particular consumer carrying out a particular transaction.

10. A method according to claim 1, comprising the step of accruing consumer sales behaviour information over time, whereby to optimise the promotional material provided to a consumer over time.

11. A method according to claim 1, comprising the provision of sets of offers for the plurality of points of sale whereby to provide maximisation of redemption uptake.

12. A system for providing consumer modelling of for sales' promotions, comprising a plurality of points of sale, a plurality of computer devices respectively adapted to analyse consumer behaviour and deliver data based thereon to a point of sale, and a device associated with an individual point of sale for providing at least promotional material to a consumer when making a sales' transaction at any individual point of sale.

13. A system according to claim 12, the points of sale comprising a network of disparate points of sale.

14. A system according to claim 12, the dedicated device comprising a printer device.
